(19) United States
(12) Patent Application Publication
(10) Pub. No.: US 2005/0096248 A1
(43) Pub. Date: May 5, 2005

(54) Cleaning method

(76) Inventors: Mark Coke, Swanland (GB); Fabio Corradini, Mira (IT); Mike Kosub, Bruchsal (DE)

Correspondence Address: NORRIS, MCLAUGHLIN & MARCUS, 875 THIRD AVE, 18TH FLOOR, NEW YORK, NY, 10022, US

(21) Appl. No.: 10/499,620

(22) PCT Filed: Dec. 19, 2002
(86) PCT No.: PCT/GB02/05781

(30) Foreign Application Priority Data
Dec. 20, 2001 (GB) 0130444.3

(51) Int. Cl. C11D 17/00

(52) U.S. Cl. 510/438

(57) ABSTRACT

This invention relates to a method of cleaning using water, in which the water is softened and/or in which the deposition of hard water scale is diminished. The invention relates in particular to such a method carried out in a domestic environment. The invention also relate to textile article products on which is reversibly impregnated or deposited a water-softening agent and their use in such methods.

This invention relates to a method of cleaning using water, in which the water is softened and/or in which the deposition of hard water scale is diminished. The invention relates in particular to such a method carried out in a domestic environment. The invention also relates to a textile product on which is reversibly impregnated or deposited at least one water-softening agent and the use of such textile products in such methods.

It is well known that certain metal compounds, notably calcium compounds, when present in water, have a significant effect on the properties of the water. “Hard” water containing a significant loading of soluble calcium and magnesium compounds and forms a scum with soap or detergent, requiring a large amount of soap or detergent in order to form a lather. Scale deposits can readily form from such water, for example on heating or pH change or evaporation.

There have been many proposals for the removal of metal ions from aqueous solutions. In the industrial context proposals have included filter beds and polymeric filters for capturing heavy metal ions from an aqueous solution flowing within a passageway. Examples are given in EP 992238A and GB 20869564A. In the domestic context chelating compositions can be added to an aqueous washing solution and these can capture metal ions, such as calcium ions. Examples of chelating compositions are given in EP-A-892040. However in a multi-step washing process, such as that carried out by a clothes washing machine, it can be a problem that the chelating agent is discharged, with the water, at an intermediate stage of the process.

There is a need for a technology which can bind metal ions, at least calcium ions and preferably other metal ions in addition, in a convenient manner, through the entire course of a cleaning procedure, including the rinse cycle of a ware washing machine, in particular a clothes' washing machine.

In accordance with a first aspect of the present invention there is provided a cleaning method which employs a textile article immersed in water, the textile article having at least one water-softening agent reversibly impregnated into, or deposited onto, the textile article.

The textile article may be so designed that the water-softening agent(s) are released over a period of time when exposed to water, for example, by partially or entirely coating the article with water-soluble polymers to delay the release of the water-softening agent(s).

One advantage of impregnating into or depositioning onto a textile article water-softening agent(s) is that discrete dosing is easily achieved and that the dosage may be varied without the need of a measuring system, as would be required for a liquid or powder. For example, half doses may be achieved by cutting or tearing the textile article in half. Alternatively multiple single doses may be provided on a single textile article which is marked, for example by printing by the use of weakened tear line(s), to single doses, multiple doses or fractional doses. Alternatively the textile article may itself be set out in such a way, for example as a printed sheet, such that the user uses a size of textile article appropriate for the hardness of the water used in the cleaning method.

We present as a further feature of the invention a kit of parts, the kit comprising:
a) a textile article as defined herein and
b) a set of instructions telling the user of the textile article to tear or cut a part of the textile article and to use the thus removed part of the textile article in a cleaning method defined herein.

Optionally the kit may also include a water hardness test.

Preferably detergent and/or bleach is absent from the textile article (“essentially free of detergent and/or bleach”).

Preferably the cleaning method is for cleaning household articles.

The method of cleaning may be a method of ware washing using a machine, for example a clothes' washing machine or a dishwashing machine.

In such methods the cleaning water is suitably produced by dissolution of a liquid or solid cleaning concentrate, preferably by addition into the machine, at or immediately after the start of the washing operation. Such concentrates suitably include one or more of an anionic surfactant, a non-ionic surfactant, an amphoteric surfactant or a cationic surfactant. For machine washing anionic and non-ionic surfactants are preferred.

A suitable anionic surfactant is an anionic organic surfactant, which is usually employed in a soluble salt form, preferably as an alkali metal salt, especially as a sodium salt. Although other types of anionic detergents may be utilized, such as higher fatty acyl sarcosides, alkyl sulphosuccinates, alkyl ether sulphosuccinates, alkylamide sulphosuccinates, alkyl sulphosuccinates, alkyl sulphoacetates, alkyl phosphates, alkyl ether phosphates, acyl isothionates, N-acyl taurates and acyl lactylates, or conventional “soaps” of fatty acids, the preferred anionic surfactants employed are those which are described as being of a sulphonate or sulphate type. These include linear higher alkylaryl sulphonates (for example alkylbenzene sulphonates), alkyl sulphates, alkyl ether sulphates, alkylamidoether sulphates, alkylarylpolyether sulphates, monoglyceride sulphates, alkyl sulphonates, alkylamido sulphonates, higher fatty alcohol sulphates, higher fatty alcohol polyalkoxylate sulphates, olefin sulphonates, ∝-methyl ester sulphonates and paraffin sulphonates. An extensive listing of anionic detergents, including such sulph(on)ate surfactants, is given at pages 25 to 138 of the text Surface Active Agents and Detergents, Vol. II, by Schwartz, Perry and Berch, published in 1958 by Interscience Publishers, Inc., and is incorporated herein by reference. Usually the higher alkyl group of such anionic surfactants is of 8 to 24, especially 10 to 20 carbon atoms, preferably 12 to 18 carbon atoms, and the alkoxylate content of such anionic surfactants that are alkoxylated (preferably ethoxylated or ethoxylated/ propoxylated) is in the range of 1 to 4 alkoxy groups per mole.

One preferred class of anionic surfactants comprise the alkali metal (preferably sodium) alkyl sulphates, preferably having linear C₁₂₋₁₈ alkyl groups.

Another preferred class of anionic surfactants comprise alkali metal (preferably sodium) alkylaryl sulphonates (especially alkylbenzene sulphonates), preferably having linear C₁₀₋₁₃ alkyl groups.

A preferred non-ionic surfactant is a condensation product of a higher fatty alcohol or alkyl phenol with a lower alkylene oxide, such as ethylene oxide or a mixture of ethylene oxide and propylene oxide. In such non-ionic surfactants the higher fatty moiety will normally be of 7 to 16 carbon atoms and there will usually be present from 3 to 20, preferably 4 to 15 moles of alkylene oxide per mole of higher fatty alcohol.

Another class of non-ionic surfactants that could be used are sorbitan esters of fatty acids having from 10 to 24 carbon atoms, for example sorbitan mono-oleate.

Amphoteric surfactants which may be used include amphoteric betaine surfactant compounds having the following general formula: 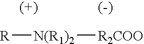
wherein R is a hydrophobic group which is an alkyl group containing from 10 to 22 carbon atoms, preferably from 12 to 18 carbon atoms, an alkylaryl or arylalkyl group containing a similar number of carbon atoms with a benzene ring being treated as equivalent to about 2 carbon atoms, and similar structures interrupted by amido or ether linkages; each R₁ is an alkyl group containing from 1 to 3 carbon atoms; and R₂ is an alkylene group containing from 1 to 6 carbon atoms.

Examples of cationic surfactants which may be used include quaternary ammonium compounds and salts thereof, including quaternary ammonium compounds which also have germicidal activity and which may be characterized by the general structural formula: 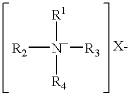
when at least one of R₁, R₂, R₃ and R₄ is a hydrophobic, aliphatic, aryl aliphatic or aliphatic aryl group containing from 6 to 26 carbon atoms, and the entire cationic portion of the molecule has a molecular weight of at least 165. The hydrophobic groups may be long-chain alkyl, long-chain alkoxy aryl, long-chain alkyl aryl, halogen-substituted long-chain alkyl aryl, long-chain alkyl phenoxy alkyl or aryl alkyl. The remaining groups on the nitrogen atoms, other than the hydrophobic radicals, are generally hydrocarbon groups usually containing a total of no more than 12 carbon atoms. The radicals R₁, R₂, R₃ and R₄ may be straight chain or may be branched, but are preferably straight chain, and may include one or more amide or ester linkages. The radical X may be any salt-forming anionic radical.

Examples of quaternary ammonium salts within the above description include the alkyl ammonium halides such as cetyl trimethyl ammonium bromide, alkyl aryl ammonium halides such as octadecyl dimethyl benzyl ammonium bromide, and N-alkyl pyridinium halides such as N-cetyl pyridinium bromide. Other suitable types of quaternary ammonium salts include those in which the molecule contains either amide or ester linkages, such as octyl phenoxy ethoxy ethyl dimethyl benzyl ammonium chloride and N-laurylcocoaminoformylmethyl)-pyridinium chloride. Other effective types of quaternary ammonium compounds which are useful as germicides includes those in which the hydrophobic radical is characterized by a substituted aromatic nucleus as in the case of lauryloxyphenyltrimethyl ammonium chloride, cetylaminophenyltrimethyl ammonium methosulphate, dodecylphenyltrimethyl ammonium methosulphate, dodecylphenyltrimethyl ammonium chloride and chlorinated dodecylphenyltrimethyl ammonium chloride.

Preferred quaternary ammonium compounds which act as germicides and which are useful in the present invention include those which have the structural formula: 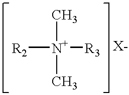
wherein R₂ and R₃ are the same or different C₈-Cl₂alkyl, or R₂ is C₁₂-C₁₆alkyl, C₈-C₁₈alkylethoxy, C₈-C₁₈alkyl-phenolethoxy and R₂ is benzyl, and X is a halide, for example chloride, bromide or iodide, or methosulphate. The alkyl groups R₂ and R₃ may be straight chain or branched, but are preferably substantially linear. It is a preferred feature of the invention to use cationic surfactant, such as those described above, in combination with a method of the invention as described herein, or with a an article for use in such methods, since the germicidal activity of such compounds is improved in softer water.

In any method of the invention, a mixture of two or more surfactants may be used. Other known surfactants not particularly described above may also be used. Such surfactants are described in McCutcheon's Detergents and Emulsifiers, North American Edition, 1982; Kirk-Othmer, Encyclopaedia of Chemical Technology, 3rd Ed., Vol. 22, pp 346-387.

The cleaning method may be a manual method, for example using a hand-cloth or mop, and an open vessel, for example a bucket or bowl. Thus, the cleaning method could be a method of cleaning a hard surface, for example a window, tiled surface, shower screen, tableware and kitchenware, a sanitaryware article, for example a shower screen, lavatory, wash basin or sink, a car (defined herein as a “household article”) or a kitchen worktop.

In such methods the cleaning agent is dissolved in water prior to the start of cleaning. The cleaning agent may comprise an anionic surfactant and/or a non-ionic surfactant, as described above. Additionally or alternatively, the cleaning agent may include one or more of an amphoteric surfactant and a cationic surfactant, as described above.

A composition used in the invention may optionally include one or more conventional additives known to be useful in cleaning compositions including bleaching agents, viscosity modification agents, fragrances (natural or synthetically produced), foaming or foam-control agents, solvents, fillers, colouring agents, and in the case of compositions for fabric washing, fabric conditioning agents, enzymes, hydrotropes and dye anti-redeposition agents. If the composition does not contain a cationic surfactant having germicidal properties as detailed above, a germicidal agent may be incorporated as an optional ingredient into the cleaning agents used in the invention. Examples are phenolic group containing compounds such as o-phenyl-phenol, o-benzyl[p-chlorophenol] and 4-tertamylphenol.

The textile article acts as a water softener within a vessel containing water, for example a bucket, sink or ware-washing machine. The cleaning agent(s) present in the water can work more effectively, and/or the vessel is soiled or scaled less, whether by soap scum or by encrustations or by watermarks left when droplets on a surface evaporate. The textile article itself can be used as the means for cleaning.

Preferably the textile article is able to move freely within the water used in the cleaning method. Thus, it is preferably not in the form of a filter or like body, retained in a fixed orientation, or mounted on a frame.

The textile article may be, for example, a woven, knitted or non-woven sheet. The sheet may if wished be secured to one or more further sheets, which may be of the same or different material, forming a ply. In one feature of the invention the water-softening agent(s) is held between the ply. Alternatively the textile article may be in the form of a thick yarn, or braid. Alternatively it may be in the form of fibres or filaments, which may, for example, be tied together in a bundle, for example in a tassel or pom-pom, or retained in a water-permeable bag.

Most preferably the textile article is a fabric sheet of relatively open form, for example a non-woven fabric or a woven fabric of scrim form. Preferably a number of fabric sheets are joined together and are demonstrated via a line of weakness.

It will be appreciated that the textile article can improve cleaning by acting as a water softener, by facilitating capture of metal ions, notably calcium ions, from the water.

Preferably the textile article is also able to bind magnesium ions. Most preferably it is able to bind further ions, for example copper and iron ions. Preferably the moieties which are able to bind calcium ions are also able to bind such further ions, notably magnesium ions.

A dye could be employed to give a colour change, on exhaustion of the available water-softening agent(s) on the textile article.

Suitable water-softening agents are those selected from below. Such components will provide three main types of method of action, described below.

1) Ion exchange agents—such agents include alkali metal (preferably sodium) aluminosilicates either crystalline, amorphous or a mixture of the two. Such aluminosilicates generally have a calcium ion exchange capacity of at least 50 mg CaO per gram of aluminosilicate, comply with a general formula:
0.8-1.5 Na₂O.Al₂O₃.0.8-6 SiO₂
and incorporate some water. Preferred sodium aluminosilicates within the above formula contain 1.5-3.0 SiO₂ units. Both amorphous and crystalline aluminosilicates can be prepared by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X, and mixtures thereof. Also of interest is zeolite P described in EP 384070 (Unilever).

Another class of compounds are the layered sodium silicate builders, such as are disclosed in U.S. Pat. No. 4,464,839 and U.S. Pat. No. 4,820,439 and also referred to in EP-A-551375.

These materials are defined in U.S. Pat. No. 4820439 as being crystalline layered, sodium silicate of the general formula
NaMSiₓO₂ₓ₊₁.YH₂O
wherein
M denotes sodium or hydrogen,
x is from 1.9 to 4 and y is from 0 to 20.

Literature references describing the preparation of such materials include Glastechn. Ber. 37,194-200 (1964), Zeitschrift fur Kristallogr. 129, 396-404 (1969), Bull. Soc. Franc. Min. Crist., 95, 371-382 (1972) and Amer. Mineral, 62, 763-771 (1977). These materials also function to remove calcium and magnesium ions from water. Also covered are salts of zinc which have also been shown to be effective water softening agents.

2) Ion capture agents—agents which prevent metal ions from forming insoluble salts or reacting with surfactants, such as polyphosphate, monomeric polycarbonates, such as citric acid or salts thereof, EDTA, algins, alginates, imidodisuccinic acid or a salt thereof (such as Baypure CX100) and glucohepatanoic acid or a salt thereof.

3) Anti-nucleating agents—agents which prevent seed crystal growth, such as polycarbonate polymers, such as polyacrylates, acrylic/maleic copolymers, and acrylic phosphonates, polyaspartic acid polymers or a salt thereof (such as Baypure DS100) and 2-acrylamido-2-methyl propane sulfonic acid polymers.

It will be appreciated that certain actives may perform more than one function, such as polyaspartic acid polymers, which as well as being antinucleating agents are also effective as ion capture agents.

Such ingredient(s) may be reversibly impregnated or deposited on the textile article by dosing a solution to the textile article and evaporating the solute. Spray drying techniques may be employed. Ionic charge may also be employed to reversibly bind anionic ionisable ingredients to the textile article.

The textile article can have bound to it such ingredients in the form of particles of a material, as described above, with those particles not being released from the textile article in use.

Alternatively the textile article could carry on it particles of a material, as described above, with those particles being washed from the textile article, and dissolved or dispersed in the wash water, in use.

Alternatively there can be a hybrid system in which some such particles remain on the textile article and some are washed off, during the method. 10782P6WO

The washing off of particles of such materials may be rapid in water or may be slow/progressive. A slow-release system may be attractive in obtaining good activity, for example calcium binding, throughout a cleaning method.

In accordance with a second aspect of the invention there is provided a method of cleaning in a ware washing machine, the method including softening the water in the machine, using a textile article having at least one water-softening agent reversibly impregnated into, or deposited onto, the textile article.

In the second aspect the textile article may be such that water is softened in the wash cycle. Preferably it is softened in the rinse cycle. Most preferably it is softened both in the wash and in the rinse cycles.

According to a third feature of the invention there is provided a textile article having at least one water softening agent reversibly impregnated into, or deposited onto, the textile article.

The invention will now be described, by way of embodiment, with reference to the following examples.

### EXAMPLE 1

A 25 cm² cellulose fibre non-woven sheet was immersed into a beaker of 6 g of Accusol 445N (polyacrylate) dissolved in 100 g of water. The sheet was removed after being saturated with the Accusol 444N solution and placed on a hard surface at ambient conditions for 24 hours. After 24 hours the non-woven sheet was found to be dry.

1. A cleaning method which employs a textile article immersed in water, the textile article having at least one water-softening agent reversibly impregnated into or deposited onto the textile article.

2. A method as claimed in claim 1, wherein the textile article changes colour on exhaustion of the available water-softening agent.

3. A method as claimed in claim 1, wherein the textile article is used as a material for wiping a surface to be cleaned.

4. A method of cleaning in a ware washing machine, the method including softening the water in the machine, using a textile article having at least one water-softening agent reversibly impregnated into or deposited onto the textile article.

5. A method according to claim 1, wherein the water-softening agent comprises calcium-binding particles which dissolve or disperse in water with which the textile article is in contact.

6. (canceled)

7. A method according to claim 1, in which the method comprises removing scale or diminishing its deposition.

8. A method according to claim 1, wherein the textile article is a cloth.

9. A method according to claim 8, wherein the textile article is a non-woven sheet.

10. A method according to claim 1, wherein the textile article comprises multiple doses.

11. A method according to claim 10, wherein the textile article is marked into single doses.

12. A method according to claim 6 wherein the textile article releases a water softening agent in the rinse cycle of the ware washing machine.

13. A method of improving the operation of a ware washing machine, by softening the water therein, the method comprising using in the machine a textile article having at least one water-softening agent reversibly impregnated into or deposited onto the textile article.

14. A method according to claim 13 wherein the textile article softens the water of the ware washing machine.

15. A textile article having at least one water softening agent reversibly impregnated into or deposited onto the textile article.

16. A textile article according to claim 15, wherein the textile article is marked into single doses.

17. A textile article according to claim 16, wherein the textile article is marked into single doses by means of printing or weakened tear line(s).

18. A kit of parts, the kit comprising:
a textile article having at least one water softening agent reversibly impregnated into or deposited onto the textile article, and
a set of instructions telling the user of the textile article to tear or cut a part of the textile article and to use the thus removed part of the textile article in a cleaning method according to claim 1.

19. A kit of parts as claimed in claim 18, wherein the kit additionally comprises a water hardness test.

20. A method according to claim 4 wherein the water-softening agent comprises calcium-binding particles which dissolve or disperse in water with which the textile article is in contact.
